(19) United States
(12) Patent Application Publication
(10) Pub. No.: US 2025/0138634 A1
(43) Pub. Date: May 1, 2025

(54) NEURAL STIMULATOR/INTERFACE, DIRECT NEURAL INTERFACE, ELECTRONIC DEVICE, NEURAL STIMULATOR/INTERFACE INITIALISATION METHOD, METHOD FOR CONTROLLING AN ELECTRONIC DEVICE AND CORRESPONDING PROGRAM

(71) Applicant: ORANGE, Issy-les-Moulineaux (FR)

(72) Inventors: Cyril Plapous, CHATILLON CEDEX (FR); Foued Bouchnak, CHATILLON CEDEX (FR)

(21) Appl. No.: 18/719,526

(22) PCT Filed: Dec. 12, 2022
(86) PCT No.: PCT/EP2022/085332

§ 371 Date: Jun. 13, 2024

(30) Foreign Application Priority Data
Dec. 16, 2021 (FR) 2113679

(51) Int. Cl. G06F 3/01

(52) U.S. Cl. CPC G06F 3/015

(57) ABSTRACT

A neural stimulator/interface, a direct neural interface, an electronic device, a neural stimulator/interface initialization method and a method for controlling an electronic device. In particular, a direct neural interface interacts with an electronic device in order to vary a control parameter of the electronic device. A neural stimulator/interface is provided that is capable of reproducing at least one signal to be reproduced with several discrete given frequencies, the given frequencies being associated with discrete given directions for adjusting a control parameter of an electronic device. Thus, the implementation of a neural interface for parameterizable controls is simplified since it requires only one frequency per control parameter setting direction instead of one frequency per value of the control parameter. A neural interface can then be implemented regardless of the number of values of the control parameter, even when this number is large.

### CROSS-REFERENCE TO RELATED APPLICATIONS

This Application is a Section 371 National Stage Application of International Application No. PCT/EP2022/085332, filed Dec. 12, 2022, and published as WO 2023/110724 A1 on Jun. 22, 2023, not in English, which claims priority to French Patent Application No. 2113679, filed Dec. 16, 2021, the contents of which are hereby incorporated by references in their entireties.

### TECHNICAL FIELD

The invention relates to a neural stimulator/interface, a direct neural interface, an electronic equipment, a neural stimulator/interface initialization method and a method for controlling an electronic equipment. In particular, the invention relates to interaction with an electronic equipment via a direct neural interface in order to vary a command parameter of the electronic equipment.

### PRIOR ART

Direct neural interfaces were introduced to make electronic equipments accessible to as many people as possible, in particular persons with physical disabilities.

Currently, electronic equipments need to be provided with a screen in order to reproduce a specific stimulus. This stimulus triggers the appearance of a particular signal, also known as a visual evoked potential, in the signals of the electroencephalogram (EEG) when the subject is subjected to visual stimulation with this stimulus. A specific equipment, for example a BCI (brain-computer interface) headset, i.e., a direct neural interface headset for measuring EEG signals, detects a frequency in these EEG signals which corresponds to the frequency of the visual stimulus.

Virtual and/or augmented reality headsets are also beginning to implement direct neural interfaces. Therefore, increasing numbers of users, including users without disabilities, may use the direct neural interface in order to facilitate and simplify interaction with electronic equipments, thereby reducing errors in interaction with equipments, including for them.

It is therefore possible to control a non-parameterizable command, such as the activation/deactivation of an electronic equipment or one of its components, by means of a neural interface. A visual stimulus is reproduced with a flashing frequency, for example. This visual stimulus is permanently active. Thus, when the user looks at it, a neural frequency is detected in the EEG signals which corresponds to the flashing frequency of the visual stimulus.

Also, the detected neural frequency triggers the command. For example, if the equipment is a lamp and, at the instant when the detected neural frequency corresponds to the flashing frequency of the visual stimulus, the lamp is switched off, the detected neural frequency triggers the lamp to be switched on (and vice-versa).

However, for electronic equipments with non-binary behavior, i.e., with a parameterizable command (the command parameter being able to assume more than two different values), the control scheme using a neural interface can be complex in terms of implementation, configuration and use, or even impossible when there is a large number of values.

### DISCLOSURE OF THE INVENTION

One of the aims of the present invention is to overcome shortcomings of the prior art.

One object of the invention is a neural stimulator/interface capable of reproducing at least one signal to be reproduced with several different given frequencies, the given frequencies being associated with different given directions of adjustment of a command parameter of an electronic equipment.

Thus, the implementation of a neural interface for parameterizable commands is simplified since it requires only one frequency per direction of adjustment of the command parameter instead of one frequency per value of the command parameter. The invention thus allows for the implementation of a neural interface regardless of the number of values of the command parameter, even when this number is large. Furthermore, the invention facilitates use of the neural interface by the user because the number of interaction stimuli is reduced to the number of directions of adjustment, which thus reduces the risk of interaction errors.

Advantageously, an order relationship between the given frequencies is a function of an order relationship between the given directions of adjustment associated with the given frequencies.

Use of the neural interface is therefore intuitive for the user, further reducing the risk of interaction errors.

Advantageously, a signal to be reproduced with a given frequency is different from a signal to be reproduced with another given frequency when the other given frequency is different from the given frequency.

Therefore, the risk of the user confusing the two stimuli generated by reproducing the signals of different frequencies is limited, further reducing the risk of interaction errors.

Advantageously, the signals to be reproduced comprise a first signal to be reproduced with a first given frequency and a second signal with a second given frequency, the first signal and the second signal being different.

Advantageously, the given frequencies are such that the difference between two given frequencies is greater than a predetermined difference threshold.

Thus, if the neural frequency detection comprises a margin of error, the difference threshold being greater than this margin of error, this limits the risk of detection error, thus reducing the risk of interaction errors.

Advantageously, the signal to be reproduced is one of the following signals: an audio signal, a visual signal.

As a result, the neural interface is accessible to a higher number of user categories, not only to sighted persons, by virtue of the visual signal, but also to persons with a visual disability, by virtue of the audio signal.

Advantageously, the neural stimulator/interface is one of the following interfaces: a neural stimulator/interface that is a component of the electronic equipment, a neural stimulator/interface connected to a communication network to which the electronic equipment is connected.

The neural interface can thus be used with a higher number of electronic equipment categories, not only electronic equipments provided with visual and/or audio reproduction devices, but also those that are not provided with a screen or loudspeakers.

One further object of the invention is a direct neural interface capable of sensing a neural frequency relating to a user during the reproduction of a signal to be reproduced with a given frequency, in which the direct neural interface comprises an emitter emitting the sensed neural frequency via a communication network, the emitter emitting the sensed neural frequency being capable of triggering an adjustment of a given command parameter of an electronic equipment, the adjustment of the command parameter being carried out in a given direction of adjustment associated with one of the given frequencies of the signals to be reproduced by a neural stimulator/interface, the given frequency associated with the given direction of adjustment being a given frequency whose emitted neural frequency is a function.

One object of the invention is also an electronic equipment, in which the electronic equipment comprises a regulator capable of adjusting a command parameter of a component of the electronic equipment in several different given directions of adjustment, a given direction of adjustment being a function of a neural frequency emitted by a direct neural interface during the reproduction of a signal to be reproduced with a given frequency by a neural stimulator/interface, the emitted neural frequency being a function of one of the given frequencies, the different given directions of adjustment being associated with different given frequencies.

Advantageously, the electronic equipment comprises a neural stimulator/interface.

Advantageously, the electronic equipment is connected to a communication network to which a connected neural stimulator/interface is connected.

One object of the invention is also a method for initializing a neural stimulator/interface, in which the initialization method comprises a pairing procedure associating a given frequency of a signal to be reproduced by a neural stimulator/interface with a given direction of adjustment of a command parameter of an electronic equipment, the different given directions of adjustment of the command parameter of the electronic equipment being associated with different given frequencies.

One object of the invention is also a method for controlling an electronic equipment, in which the control method adjusts a command parameter of an electronic equipment in a given direction of adjustment as a function of a neural frequency received from a direct neural interface during the reproduction of a signal to be reproduced with a given frequency by a neural stimulator/interface, the received neural frequency being a function of the given frequency, the different given directions of adjustment being associated with different given frequencies.

Advantageously, according to one implementation of the invention, the different steps of the method according to the invention are implemented by software or a computer program, this software comprising software instructions intended to be executed by a data processor of a device that is part of a neural stimulator/interface and/or an electronic equipment and/or a connected objects manager and being designed to command the execution of the different steps of this method.

The invention therefore also relates to a program comprising program code instructions for executing the steps of the method for initializing a neural stimulator/interface and/or the method for controlling an electronic equipment when said program is executed by a processor.

This program may use any programming language and be in the form of source code, object code or intermediate code between source code and object code, for example being in a partially compiled form or in any other desired form.

### BRIEF DESCRIPTION OF THE DRAWINGS

The features and advantages of the invention will become clearer upon reading the description, provided as an example, and viewing the corresponding figures in which:

FIG. 1a is a simplified diagram of an architecture comprising a neural stimulator/interface and an electronic equipment according to the invention,

FIG. 1b is a simplified diagram of an architecture including an electronic equipment comprising a neural stimulator/interface according to the invention,

FIG. 2 is a simplified diagram of an architecture comprising a manager of connected objects including a connected neural stimulator/interface and an electronic equipment according to the invention,

FIG. 3 is a simplified diagram of exchanges during the implementation of a method for initializing a neural stimulator/interface according to the invention,

FIG. 4 is a simplified diagram of exchanges during the implementation of a method for controlling an electronic equipment using a neural stimulator/interface according to the invention,

FIG. 5a is a simplified diagram of a neural stimulator/interface issuing two stimuli at different given frequencies associated with two different positions of a physical button of an electronic equipment according to the invention,

FIG. 5b is a simplified diagram of a neural stimulator/interface issuing four stimuli at different given frequencies associated with four different positions of a physical button of an electronic equipment according to the invention,

FIG. 5c is a simplified diagram of a neural stimulator/interface issuing two stimuli at different given frequencies associated with two different zones of interaction of an interface displayed by an electronic equipment according to the invention.

### DESCRIPTION OF THE EMBODIMENTS

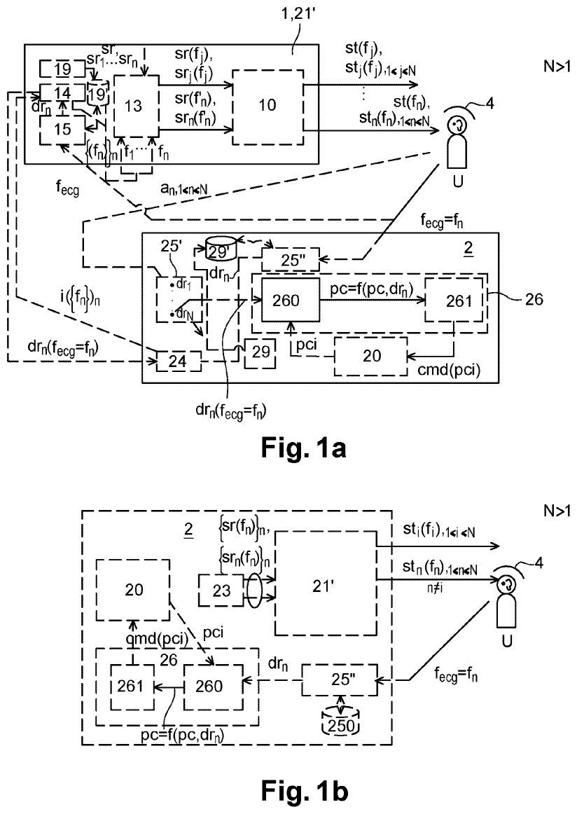

FIGS. 1a and 1b show simplified diagrams of an architecture comprising a neural stimulator/interface and an electronic equipment according to the invention, respectively generally and in the case of an electronic equipment comprising the neural stimulator/interface according to the invention.

FIG. 1a shows a simplified diagram of an architecture comprising a neural stimulator/interface and an electronic equipment according to the invention.

A neural stimulator/interface 1,21′ is capable of reproducing at least one signal to be reproduced sr, {srₙ}_{n,1≤n≤N,1>N} with several different given frequencies {fₙ}_{n,1≤n≤N,1>N}: {sr(fₙ)}_{n,1≤n≤N,1>N}, {srₙ(fₙ)}_{n,1≤n≤N,1>N}. The given frequencies {fₙ}_{n,1≤n≤N,1>N} are associated with different given directions of adjustment {dr}_{n,1≤n≤N,1>N} of a command parameter pci (also referred to as {dr_pci}_{n,1≤n≤N,1>N}) of an electronic equipment 2.

Thus, the implementation of a neural interface for parameterizable commands is simplified since it requires only one frequency per direction of adjustment of the command parameter instead of one frequency per value of the command parameter. The invention thus allows for the implementation of a neural interface regardless of the number of values of the command parameter, even when this number is large. Furthermore, the invention facilitates use of the neural interface by the user because the number of interaction stimuli is reduced to the number of directions of adjustment, which thus reduces the risk of interaction errors.

“Given” should be understood in particular to mean “defined”, “set” or “determined”. A given frequency fₙ and a given direction of adjustment drₙ possibly correspond respectively to a frequency and a direction of adjustment chosen, for example, by the user U or during the assembly of the electronic equipment 2 and/or the neural stimulator/interface 1,21′, in particular when associating the neural stimulator/interface 1,21′ with the electronic equipment 2 or with a component 20 of electronic equipment.

A direction of adjustment of a command parameter may also be taken to mean, in particular, an orientation of adjustment of a command parameter. The direction of adjustment of a command parameter is, for example, one of the following directions: adjustment towards higher values of the command parameter, adjustment towards lower values of the command parameter, adjustment towards a position of the command parameter further to the right, further to the left, further up, further down, etc.

A given frequency fₙ of reproduction of a signal to be reproduced by a neural stimulator/interface 1 is associated with a direction of adjustment drₙ of a command parameter pci of an electronic equipment 2.

In particular, the neural stimulator/interface 1,21′ comprises a reproduction device 10 capable of reproducing the signal or signals to be reproduced sr, {srₙ}_{n,1≤n≤N,1>N} with the given frequencies f{fₙ}_{n,1≤n≤N,1>N}. The reproduction device 10 is in particular a visual reproduction device such as a 2D or 3D screen, etc. (the screen comprising at least one pixel that can vary, in particular switching on or switching off, at at least one predefined frequency), one or more light-emitting or laser diodes (in particular a mosaic of light-emitting diodes), a holograph, etc., a 2D or 3D audio reproduction device with or without spatialization comprising one or more loudspeakers, a stereophonic device, etc.

The issuing of a stimulus st, stₙ with the given frequency fₙ by the neural stimulator/interface 1,21′ results from the reproduction of a signal to be reproduced sr, srₙ with a given frequency fₙ. This stimulus st, stₙ with the given frequency fₙ induces, in the brain of the user who is concentrating on the stimulus st, stₙ with the given frequency fₙ, in particular who is looking at the stimulus when it is visual, an evoked potential, in particular a visual evoked potential, the neural frequency f_{ecg} of which is a function of the given frequency fₙ.

The neural stimulator/interface 1,21′, in particular the reproduction device 10, issues, in particular displays, with stimuli st, {stₙ}_{n,1≤n≤N,1>N} with the given frequencies {fₙ}_{n,1≤n≤N,1>N}: {st(fₙ)}_{n,1≤n≤N,1>N}, {stₙ(fₙ)}_{n,1≤n≤N,1>N} corresponding to the reproduction of the signals to be reproduced {sr(fₙ)}_{n,1≤n≤N,1>N}, {srₙ(fₙ)}_{n,1≤n≤N,1>N} with the given frequencies {fₙ}_{n,1≤n≤N,1>N}. The stimuli {st(fₙ)}_{n,1≤n≤N,1>N}, {stₙ(fₙ)}_{n,1≤n≤N,1>N} are perceptible, in particular being visible in the case of visual stimuli or audible in the case of audio stimuli, to a user U.

In particular, an order relationship ro({fₙ}ₙ) between the given frequencies (for example ro=f1>f2) is a function of an order relationship ro({drₙ}ₙ) between the given directions of adjustment (for example ro=dr1>dr2) associated with the given frequencies: ro({fₙ}ₙ)=f(ro({drₙ}ₙ)).

An order relationship of a dataset is a relationship that compares the data of this set with each other in a coherent manner. The order relationship provides data ordered as a function of the comparison made, for example in ascending order, descending order, etc.

Use of the neural interface is therefore intuitive for the user, further reducing the risk of interaction errors.

In particular, a signal to be reproduced with a given frequency srₙ(fₙ) is different from a signal to be reproduced with another given frequency srⱼ(fⱼ): srₙ(fₙ)≠srⱼ(fⱼ) when the other given frequency fₙ is different from the given frequency fⱼ: fₙ≠fⱼ.

Therefore, the risk of the user confusing the two stimuli generated by reproducing the signals of different frequencies is limited, further reducing the risk of interaction errors.

In particular, the signals to be reproduced {srₙ(fₙ)}_{n,1≤n≤N,1>N} comprise a first signal to be reproduced with a first given frequency sr₁(f₁) and a second signal with a second given frequency sr₂(f₂), the first signal and the second signal being different sr₁≠sr₂.

Therefore, the two stimuli are not only different in terms of frequency but also in terms of the nature of the signals to be reproduced that have generated them. For example, when the signals to be reproduced are visual, the first signal to be reproduced may have a color, tonality (lighter, darker), etc. different from the second signal to be reproduced; and when the signals to be reproduced are audio, the first signal to be reproduced may have a volume (louder, softer), a nuance (mezzo forte, forte, piano, etc.) different from the second signal to be reproduced; etc.

In particular, the given frequencies {fₙ}_{n,1≤n≤N,1>N} are such that the difference between two given frequencies Δ_{fn,j}=|fₙ−fⱼ| is greater than a predetermined difference threshold Sd.

In particular, the signal to be reproduced sr, {srₙ}_{n,1≤n≤N,1>N} is one of the following signals: an audio signal, a visual signal.

Using a visual signal helps limit the risk of interaction errors because it is easier for the user to focus on one of the stimuli generated from visual signals to be reproduced; it is sufficient for the user to look at a single stimulus or direct his or her gaze towards a single stimulus.

Using an audio signal offers an advantage in situations in which visual stimuli are not accessible to the user, either because he or she has a visual disability, or because of the ambient lighting, or because of the position of the user in relation to the neural stimulator/interface (not in the same room, or positioned facing away from the neural stimulator/interface, etc.), etc. Therefore, an audio signal to be reproduced allows neural interaction in conditions in which it would be impossible or difficult for a visual signal to be reproduced, avoiding errors in the implementation of the electronic equipment, in particular linked not only to interaction errors but also to lack of interaction.

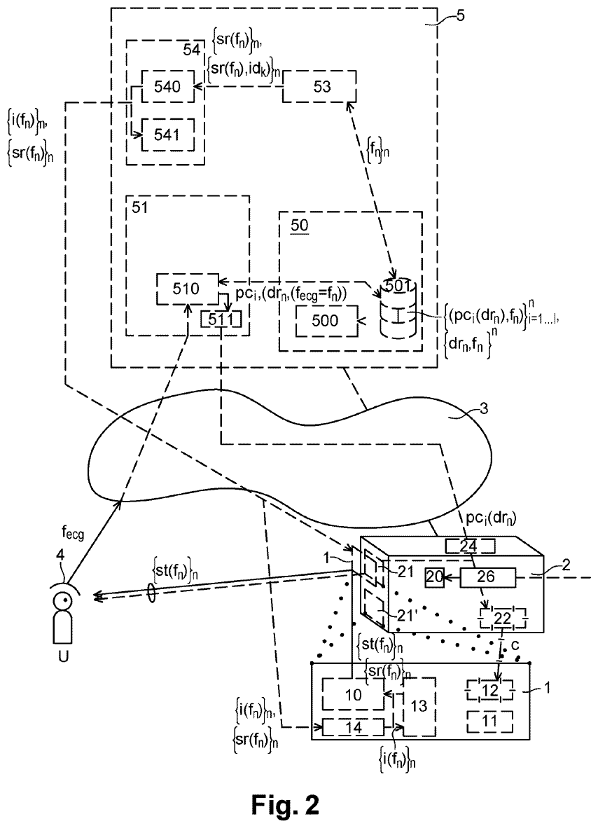

In particular, the neural stimulator/interface 1,21′ is one of the following interfaces: a neural stimulator/interface 21′ that is a component 20 of the electronic equipment 2 (as shown, in particular, in FIG. 1b), a neural stimulator/interface 1 connected to a communication network 3 to which the electronic equipment 2 is connected (as shown, in particular, in FIG. 2).

In particular, the neural stimulator/interface 1 is connected to a communication network 3 (not shown) to which the electronic equipment is connected.

In particular, the connected neural stimulator/interface 1 is connected to the communication network 3 via a wireless local area network such as Wi-Fi, Bluetooth, LoRa, etc.

In one particular embodiment, in which the neural stimulator/interface 1 is a device separate from the electronic equipment 2:
the neural stimulator/interface 1 comprises, in particular, a fastening 11 (not shown) capable of holding the neural stimulator/interface 1 in relation to a physical button 25′ of the electronic equipment with which the neural stimulator/interface 1 is associated.
the neural stimulator/interface 1 comprises, in particular, a rechargeable battery 12 (not shown). In particular, the neural stimulator/interface 1 may be connected for power supply purposes to any electronic device, such as the electronic equipment 2, a computer, a tablet, etc. in particular by means of a USB cable, in order to be recharged, or indeed to a power socket via a battery charger.

A direct neural interface 4 is capable of sensing a neural frequency f_{ecg} relating to a user U during the reproduction of signals to be reproduced with given frequencies {sr(fₙ)}_{n,1≤n≤N,1>N}, {srₙ(fₙ)}_{n,1≤n≤N,1>N}. The direct neural interface 4 comprises an emitter 44 (not shown) emitting the sensed neural frequency f_{ecg} via a communication network (not shown). The emitter 44 emitting the sensed neural frequency f_{ecg} is capable of triggering an adjustment of a command parameter pci of an electronic equipment 2 in a given direction drₙ. The adjustment of the command parameter pci is carried out in a given direction of adjustment drₙ associated with one of the given frequencies fₙ of the signals to be reproduced sr(fₙ), srₙ(fₙ) by a neural stimulator/interface 1, the given frequency fₙ associated with the given direction of adjustment drₙ being a given frequency whose emitted neural frequency f_{ecg} is a function.

The neural frequency f_{ecg} is more precisely a function of the given frequency fₙ corresponding to the stimulus st(fₙ), stₙ(fₙ) generated by the reproduction of a signal to be reproduced using the given frequency sr(fₙ), srₙ(fₙ) on which the user U has focused. In particular, the sensed neural frequency f_{ecg} is a frequency of an evoked potential signal in signals of the electroencephalogram of a user U.

An electronic equipment 2 comprises a regulator 260 capable of adjusting a command parameter pci of a component 20 of the electronic equipment 2 in several different given directions of adjustment {dr}_{n,1≤n≤N,1>N}. A given direction of adjustment drₙ is a function of a neural frequency f_{ecg} emitted by a direct neural interface 4 during the reproduction of a signal to be reproduced with a given frequency {sr(fₙ)}_{n,1≤n≤N,1>N}, {srₙ(fₙ)}_{n,1≤n≤N,1>N} by a neural stimulator/interface. The emitted neural frequency f_{ecg} is a function of one of the given frequencies f_{n,1≤n≤N,1>N}. The different given directions of adjustment {dr}_{n,1≤n≤N,1>N} are associated with different given frequencies {fₙ}_{n,1≤n≤N,1>N}.

A regulator 260 is, in particular, an apparatus that is intended to vary a physical quantity, for example a parameter, that is involved in the operation of an installation, such as an apparatus intended to adjust speed, voltage, current, volume, position, etc.

In particular, the electronic equipment 2 comprises an actuator 26 including the regulator 260 that is capable of operating a component 20 of the electronic equipment 2 as a function of at least one command using the command parameter pci that can be adjusted as a function of the given directions of adjustment {dr}_{n,1≤n≤N,1>N}.

The actuator 26 comprises, in particular, an elementary actuator 261 using the command parameter pci=f(pci, drₙ) adjusted by the regulator 260 as a function of the direction of adjustment drₙ determined from the received neural frequency f_{ecg}.

In particular, the elementary actuator 261 and/or the actuator 26 is a processor capable of executing a processing operation as a function of at least one command using the command parameter pci that can be adjusted as a function of the given directions of adjustment {dr}_{n,1≤n≤N,1>N}.

In particular, the electronic equipment 2 comprises a neural stimulator/interface 1 according to the invention.

In one particular embodiment, in which the electronic equipment 2 is a device separate from the neural stimulator/interface 1, the electronic equipment 2 comprises a power supply 22 (not shown) for the neural stimulator/interface when the neural stimulator/interface 1 is associated with a direction of adjustment of a command parameter of the electronic equipment 2.

In particular, the power supply 22 implemented in the electronic equipment 2 recharges c the battery 12 of the neural stimulator/interface 1 in particular when the neural stimulator/interface 1 is connected to the electronic equipment 2, for example by cable, by induction, etc.

In particular, the power supply for the connected neural stimulator/interface 22 is one of the following power supplies:
a power supply connector capable of being connected to the connected neural stimulator/interface when the connected neural stimulator/interface is associated with a physical button of the electronic equipment;
an induction charger capable of recharging a battery of the connected neural stimulator/interface when the connected neural stimulator/interface is associated with a physical button of the electronic equipment.

In particular, a controller 15, 25″ is capable of controlling an electronic equipment 2 as a function of a neural frequency f_{ecg} received from a direct neural interface 4 during the reproduction of signals to be reproduced sr, {srₙ}_{n,1≤n≤N,1>N} with given frequencies {fₙ}_{n,1≤n≤N,1>N} by the connected neural stimulator/interface 1, 21′. The received neural frequency f_{ecg} is a function of one of the given frequencies fₙ.

In particular, the given frequency fₙ of which the received neural frequency f_{ecg} is a function is the given frequency fₙ of the stimulus on which the user U has focused, the stimulus st of given frequency fₙ resulting from the reproduction of a signal to be reproduced with the given frequency fₙ: sr(fₙ), srₙ(fₙ).

In particular, the controller 15, 25″ is capable of controlling an electronic equipment 2 as a function of a neural frequency f_{ecg} received from a direct neural interface 4 as soon as the user U of the direct neural interface 4 performs an action an relating to the reproduction of a signal to be reproduced sr(fₙ), srₙ(fₙ) with a given frequency fₙ by the neural stimulator/interface 1, 21′. The action aₙ performed by the user U is, in particular, that of looking at the visual stimulus st(fₙ) resulting from the reproduction of a visual signal to be reproduced sr(fₙ), srₙ(fₙ) with the given frequency fₙ.

In particular, the controller 15, 25″ comprises an analyzer 150, 250″ (not shown) capable of determining a given direction of adjustment drₙ of a command parameter pci of the electronic equipment 2 as a function of a neural frequency f_{ecg} received from a direct neural interface 4 during the reproduction by the connected neural stimulator/interface 1, 21′ of signals to be reproduced sr, {srₙ}_{n,1≤n≤N,1>N} with given frequencies {fₙ}_{n,1≤n≤N,1>N} associated with the given directions of adjustment {dr}_{n,1≤n≤N,1>N} of the command parameter pci.

In particular, the analyzer 510 requests from the storage device 501 the given command cmdₙ associated with a given frequency fₙ corresponding to the received neural frequency f_{ecg} and supplies the given command cmdₙ to the electronic equipment 2.

In particular, when the neural stimulator/interface 1 separate from the electronic equipment 2 comprises the controller 15, the controller 15 comprises an emitter 151 (not shown) emitting a direction of adjustment to the electronic equipment 2, the emitter emitting a direction of adjustment emitting a given direction of adjustment drₙ associated with a given frequency fₙ corresponding to the received neural frequency f_{ecg}.

In particular, the analyzer 150, 250″ supplies the given direction of adjustment drₙ to the command emitter 151.

In particular, the emitter 151 transmits the given direction of adjustment drₙ to the electronic equipment over an MQTT (Message Queuing Telemetry Transport) bus by using, in particular, a Wi-Fi protocol.

In particular, when the electronic equipment 2 comprises the controller 25″, the controller 25″ comprises a trigger 251″ (not shown) capable of causing the command parameter pci to be adjusted, by the electronic equipment 2, in a given direction of adjustment drₙ associated with a given frequency fₙ corresponding to the received neural frequency f_{ecg}: drₙ(f_{ecg}=fₙ).

The neural stimulator/interface 1 is possibly physically associated ph_ass (not shown) with a physical button 25′ of the electronic equipment 2. Operating the physical button triggers adjustment of the command parameter pci in the given direction of adjustment drₙ.

In particular, the reproduction device 10 of the neural stimulator/interface reproduces the signals to be reproduced with the given frequencies {sr(fₙ)}_{n,1≤n≤N,1>N}, {srₙ(fₙ)}_{n,1≤n≤N,1>N}.

When the user U is looking at one of the stimuli {st(fₙ)}_{n,1≤n≤N,1>N}, {srₙ(fₙ)}_{n,1≤n≤N,1>N} resulting from the reproduction of the signals to be reproduced with the given frequencies {sr(fₙ)}_{n,1≤n≤N,1>N}, {srₙ(fₙ)}_{n,1≤n≤N,1>N} by the neural stimulator/interface 1, 21′: the stimulus of given frequency fₙ, a direct neural interface 4 senses a neural frequency f_{ecg} relating to the user U. The sensed neural frequency f_{ecg} and the given frequency fₙ have the same value.

In particular, the direct neural interface 4 is implemented in a BCI headset or an augmented reality headset that has EEG capabilities, i.e., electroencephalogram signal detection capabilities.

The direct neural interface 4 supplies the sensed neural frequency f_{ecg} via a communication interface 44. An adjustment of a command parameter pci in a given direction of adjustment drₙ that is a function of the sensed neural frequency f_{ecg} is implemented by the electronic equipment 2.

An analyzer 15, 25″ possibly determines the given direction of adjustment drₙ as a function of the neural frequency emitted by the direct neural interface 4 and the pairing associating a given direction of adjustment and a given frequency (drₙ,fₙ). The analyzer 15 or 25″ is, in particular, implemented in the neural stimulator/interface 1 or the electronic equipment 2 or the direct neural interface 4 (not shown).

In one particular embodiment using an augmented reality headset (not shown) implementing the direct neural interface 4, the augmented reality headset further comprises at least one connected neural stimulator/interface 1.

The augmented reality headset therefore reproduces, in a given geographical area associated with the electronic equipment 2, in particular with a physical button 25′ of this electronic equipment 2, the signals to be reproduced with the given frequencies {sr(fₙ)}_{n,1≤n≤N,1>N}, {srₙ(fₙ)}_{n,1≤n≤N,1>N} associated with the given directions of adjustment drₙ of a command parameter pci of the electronic equipment 2, in particular adjustment by means of the physical button 25′.

In particular, the reproduction device 10 of the connected neural stimulator/interface 1 is the reproduction device of the augmented reality headset implemented for reproduction in the given geographical area.

The augmented reality headset implementing neural stimulators/interfaces therefore makes it possible to easily associate several neural stimulators/interfaces for a given electronic equipment but also to associate neural stimulators/interfaces with a large number of electronic equipments. This increases the possibilities of equipping electronic equipments (television, computer, tablet, smartphone, smart plugs, smart switches, Hi-Fi, smart speakers, home router, TV decoder, DVD player, connected household appliances, remote control, keyboard, bus stop request button, etc.) with neural interaction means, but above all the number of electronic equipments equipped with neural interaction means in a location, such as a home, an office, etc.

In one particular embodiment, the given frequencies {fₙ}_{n,1≤n≤N,1>N} of the neural stimulator/interface 1,21′ are associated with the given directions of adjustment {dr}_{n,1≤n≤N,1>N} of a command parameter pci of the electronic equipment 2 prior to the first use of the neural stimulator/interface 1, in particular during manufacture of the electronic equipment 2 comprising the neural stimulator/interface 21′, or when associating the external neural stimulator/interface 1 with the electronic equipment 2. “External” neural stimulator/interface should be understood to mean that the neural stimulator/interface and the electronic equipment are separate devices connected to each other directly, either by cable (USB, Ethernet, data bus etc.) or by means of a local wireless connection: Bluetooth, Wi-Fi, LoRa, Li-Fi, etc.

In one particular embodiment, the given frequencies {fₙ}_{n,1≤n≤N,1>N} of the neural stimulator/interface 1,21′ are associated with the given directions of adjustment {dr}_{n,1≤n≤N,1>N} of a command parameter pci of the electronic equipment 2 at any time, including between two uses of the neural stimulator/interface 1, 21′. This makes it possible to reconfigure the given frequencies used in order to better adapt them to neural interaction, in particular manually or automatically (for example as a function of a calculated interaction error rate), but also the given directions of adjustment of command parameters in order to possibly add directions of adjustment and/or command parameters to the neural interaction.

In particular, a pairing unit 19,29 associates the given frequencies {fₙ}_{n,1≤n≤N,1>N} of signals to be reproduced sr, {srₙ}_{n,1≤n≤N,1>N} reproduced by the neural stimulator/interface 1, 21′ with given directions of adjustment {dr}_{n,1≤n≤N,1>N} of a command parameter pci of the electronic equipment 2.

In particular, the pairing unit 19,29 comprises a storage device 191, 291 storing the given direction of adjustment/given frequency pairs of a command parameter {(drₙ, fₙ)}ₙ. The storage device 191, 291 is a memory, a database of command parameters, etc.

In particular, the pairing unit 19,29 comprises a recorder 190, 290 (not shown) capable of storing the given direction of adjustment/given frequency pairs of a command parameter {(drₙ, fₙ)}ₙ, in particular in a storage device 191, 291 of the neural stimulator/interface 1 and the electronic equipment 2 respectively.

In particular, the neural stimulator/interface 1 or the electronic equipment 2 comprises the pairing unit 19 or 29.

In particular, the signals to be reproduced are supplied by a generator for generating signals to be reproduced 13, 23. The generator 13,23 for generating signals to be reproduced sr, {srₙ}_{n,1≤n≤N,1>N} possibly generates at least one signal sr, {srₙ}_{n,1≤n≤N,1>N} with several different given frequencies {fₙ}_{n,1≤n≤N,1>N}: {sr(fₙ)}_{n,1≤n≤N,1>N}, {srₙ(fₙ)}_{n,1≤n≤N,1>N}. The signals to be reproduced generated in this way {sr(fₙ)}_{n,1≤n≤N,1>N}, {srₙ(fₙ)}_{n,1≤n≤N,1>N} are capable of being reproduced by a connected neural stimulator/interface 1, 21′. In particular, the generator 13,23 supplies the signals to be reproduced generated in this way {sr(fₙ)}_{n,1≤n≤N,1>N}, {srₙ(fₙ)}_{n,1≤n≤N,1>N} to the reproduction device 10.

In particular, the neural stimulator/interface 1,21′ or the electronic equipment 2 comprises a generator 13 or 23 for generating signals to be reproduced sr, {srₙ}_{n,1≤n≤N,1>N} with several different given frequencies {fₙ}_{n,1≤n≤N,1>N}.

If the electronic equipment 2 comprises the generator 23 (not shown), the generator 23 supplies the generated signals {sr(fₙ)}_{n,1≤n≤N,1>N}, {srₙ(fₙ)}_{n,1≤n≤N,1>N}, possibly with an identifier of the destination neural stimulator/interface idₖ, to the transmitter 24, in particular to the emitter 240 (not shown). The transmitter 24 then emits the generated signals to the neural stimulator/interface 1 in question, in particular to the reproduction device 10, possibly via the transmitter 14 of the neural stimulator/interface 1 in question, or the receiver 140 (not shown).

If the neural stimulator/interface 1,21′ comprises the generator 13, the generator 13 generates the signals to be reproduced, for example as a function of given frequencies to be reproduced sr, {srₙ}_{n,1≤n≤N,1>N} with several different given frequencies {fₙ}_{n,1≤n≤N,1>N} received with an indication signal i({fₙ}_{n,1≤n≤N,1>N}) indicating the given frequencies {fₙ}_{n,1≤n≤N,1>N} coming, in particular, from the electronic equipment 2.

Several neural stimulators/interfaces 1,21′ may possibly be used for the adjustment of different command parameters pci (i=1 . . . . I) of one or more electronic equipments 2 by means of the direct neural interface 4.

FIG. 1b shows a simplified diagram of an architecture including an electronic equipment comprising a neural stimulator/interface according to the invention.

An electronic equipment 2 comprises a neural stimulator/interface 21′.

The neural stimulator/interface 21′ is capable of reproducing at least one signal to be reproduced sr, {srₙ}_{n,1≤n≤N,1>N} with several different given frequencies {fₙ}_{n,1≤n≤N,1>N}: {sr(fₙ)}_{n,1≤n≤N,1>N}, {srₙ(fₙ)}_{n,1≤n≤N,1>N}. The given frequencies {fₙ}_{n,1≤n≤N,1>N} are associated with different given directions of adjustment {dr}_{n,1≤n≤N,1>N} of a command parameter pci (also referred to as {dr_pci}_{n,1≤n≤N,1>N}) of an electronic equipment 2.

The neural stimulator/interface 21′ of FIG. 1b corresponds to the neural stimulator/interface 21′ described in reference to FIG. 1a.

A direct neural interface 4 is capable of sensing a neural frequency f_{ecg} relating to a user U during the reproduction of a signal to be reproduced a with given frequency {sr(fₙ)}_{n,1≤n≤N,1>N}, {srₙ(fₙ)}_{n,1≤n≤N,1>N}. The direct neural interface 4 comprises an emitter 44 (not shown) emitting the sensed neural frequency f_{ecg} via a communication network (not shown). The emitter 44 emitting the sensed neural frequency f_{ecg} is capable of triggering an adjustment of a command parameter pci of an electronic equipment 2. The adjustment of the command parameter pci is carried out in a given direction of adjustment drₙ associated with one of the given frequencies fₙ of the signals to be reproduced sr(fₙ), srₙ(fₙ) by a neural stimulator/interface 1, the given frequency fₙ associated with the given direction of adjustment drₙ being a given frequency whose emitted neural frequency f_{ecg} is a function.

The electronic equipment 2 comprises a regulator 260 capable of adjusting a command parameter pci of a component 20 of the electronic equipment 2 in several different given directions of adjustment {dr}_{n,1≤n≤N,1>N}. A given direction of adjustment {dr}_{n,1≤n≤N,1>N} is a function of a neural frequency f_{ecg} emitted by a direct neural interface 4 during the reproduction of a signal to be reproduced with a given frequency {sr(fₙ)}_{n,1≤n≤N,1>N}, {srₙ}_{n,1≤n≤N,1>N} by a neural stimulator/interface. The emitted neural frequency f_{ecg} is a function of one of the given frequencies f_{n,1≤n≤N,1>N}. The different given directions of adjustment {dr}_{n,1≤n≤N,1>N} are associated with different given frequencies {fₙ}_{n,1≤n≤N,1>N}.

The electronic equipment 2 of FIG. 1b corresponds to the electronic equipment 2 described in reference to FIG. 1a.

FIG. 2 shows a simplified diagram of an architecture comprising a manager of connected objects including a connected neural stimulator/interface and an electronic equipment according to the invention.

A manager 5 of objects connected to a communication network 3 including at least a connected neural stimulator/interface 1, 21′ and an electronic equipment 2 is possibly used to implement the invention.

“Object” should be understood to mean any solid item considered as a whole, manufactured and intended for a certain use. A connected object is an object capable of exchanging a signal via a home communication network (via a wired LAN or wireless Wi-Fi network, Bluetooth, LoRa, etc.) and/or a remote communication network such as the wired Internet (ADSL, fiber, etc.) or the wireless Internet (4G, 5G, etc.) with at least one electronic device such as a service delivery device.

“Connected object” should be understood to mean physical or virtual objects interconnected via at least one local and/or remote communication network in order to provide advanced services using information and/or communication technologies.

The communication network 3 is a remote or local home network.

In particular, the connected neural stimulator/interface 1 is connected to a network referred to as an IoT (Internet of things) network, managed by the connected objects manager 5. The IoT network is in particular associated with a specific location, such as the user's home, a workshop and/or a company building, etc.

In particular, the connected neural stimulator/interface 1 is connected to the communication network 3 via a wireless local area network such as Wi-Fi, Bluetooth, LoRa, etc.

In particular, a connected objects manager 5 comprises a pairing unit 50 capable of associating given frequencies {fₙ}_{n,1≤n≤N,1>N} of at least one signal to be reproduced {sr(fₙ)}_{n,1≤n≤N,1>N}, {srₙ(fₙ)}_{n,1≤n≤N,1>N} reproduced by a neural stimulator/interface 1, 21′ connected to the communication network 3, with different given directions of adjustment {dr}_{n,1≤n≤N,1>N} of a command parameter pci of an electronic equipment 2 connected to the communication network 3.

In particular, the pairing unit 50 comprises a storage device 501 storing given direction of adjustment of a command parameter pci/given frequency pairs {(drₙ, fₙ)}ₙ. The storage device 501 is a memory, a database of directions of adjustment of command parameters, etc.

In particular, the pairing unit 50 comprises a recorder 500 capable of storing the given direction of adjustment of a command parameter pci/given frequency pair (drₙ,fₙ), in particular in a storage device 501 of the connected objects manager 50.

In particular, a connected objects manager 5 comprises a controller 51 capable of controlling an electronic equipment 2 connected to the communication network 3 as a function of a neural frequency f_{ecg} received from a direct neural interface 4 during the reproduction of signals to be reproduced {sr(fₙ)}_{n,1≤n≤N,1>N}, {srₙ(fₙ)}_{n,1≤n≤N,1>N} with the given frequencies {fₙ}_{n,1≤n≤N,1>N} by the connected neural stimulator/interface 1, 21′. The received neural frequency f_{ecg} is a function of the given frequency fₙ.

In particular, the controller 51 is capable of controlling an electronic equipment 2 connected to the communication network 3 as a function of a neural frequency f_{ecg} received from a direct neural interface 4 as soon as the user U of the direct neural interface 4 performs an action relating to the reproduction of a signal to be reproduced sr(fₙ), srₙ(fₙ) with a given frequency fₙ by the connected neural stimulator/interface 1, 21′. The action performed by the user U is, in particular, that of looking at stimuli st(fₙ), stₙ(fₙ) resulting from the reproduction of a signal to be reproduced sr(fₙ), srₙ(fₙ) with the given frequency fn, when the signals to be reproduced are visual signals and therefore the stimuli are visual stimuli.

In particular, the controller 51 comprises an analyzer 510 capable of determining a given direction of adjustment drₙ of a command parameter pci of the electronic equipment 2 as a function of a neural frequency f_{ecg} received from a direct neural interface 4 during the reproduction by the connected neural stimulator/interface 1, 21′ of signals to be reproduced {sr(fₙ)}_{n,1≤n≤N,1>N}, {srₙ(fₙ)}_{n,1≤n≤N,1>N} with given frequencies including a signal to be reproduced with the given frequency fₙ associated with the given direction of adjustment drₙ of a command parameter pci.

In particular, the analyzer 510 requests from the storage device 501 the given direction of adjustment drₙ of a command parameter pci associated with a given frequency fₙ corresponding to the received neural frequency f_{ecg} and supplies the given direction of adjustment drₙ of the command parameter pci to the electronic equipment 2.

In particular, the controller 51 comprises an emitter 511 emitting directions of adjustment to the electronic equipment 2, the command emitter emitting a given direction of adjustment drₙ of a command parameter pci associated with a given frequency fₙ corresponding to the received neural frequency f_{ecg}.

In particular, the analyzer 510 supplies the given direction of adjustment drₙ of a command parameter pci to the command emitter 511.

In particular, the connected objects manager 5 transmits the given direction of adjustment drₙ of a command parameter pci to the electronic equipment over an MQTT (Message Queuing Telemetry Transport) bus by using, in particular, a Wi-Fi protocol, in particular when the connected objects manager 5 is remote from the electronic equipment 2.

The controller 51 possibly comprises a trigger 511 capable of initiating the implementation and/or the execution, by the electronic equipment 2, of a given direction of adjustment drₙ of a command parameter pci associated with a given frequency fₙ corresponding to the received neural frequency f_{ecg}: cmdₙ(f_{ecg}=fₙ).

In a first architecture (not shown), a first connected objects manager 5′ comprises the pairing unit 50′ and a second objects manager 5″ comprises the controller 51″.

Alternatively, in a second architecture shown in FIG. 2, a connected objects manager 5 comprises the pairing unit 50 and the controller 51. In particular, the connected objects manager 5 comprises:
the pairing unit 50 for pairing given frequencies {fₙ}_{n,1≤n≤N,1>N} of signals to be reproduced {sr(fₙ)}_{n,1≤n≤N,1>N}, {srₙ(fₙ)}_{n,1≤n≤N,1>N} reproduced by the connected neural stimulator/interface 1, 21′ with different given directions of adjustment {dr}_{n,1≤n≤N,1>N} of a command parameter pci of an electronic equipment 2, and
the controller 51 for controlling connected equipments as a function of a neural frequency f_{ecg} received from a direct neural interface 4 during the reproduction of signals to be reproduced {sr(fₙ)}_{n,1≤n≤N,1>N}, {srₙ(fₙ)}_{n,1≤n≤N,1>N} with the given frequencies {fₙ}_{n,1≤n≤N,1>N} by the connected neural stimulator/interface 1, 21′.

In particular, the connected objects manager 5 comprises a transmitter 54 exchanging a signal i(fₙ), sv(fₙ) relating to the given frequencies {fₙ}_{n,1≤n≤N,1>N} with the connected neural stimulator/interface 1, 21′.

In particular, the signal relating to the given frequencies {fₙ}_{n,1≤n≤N,1>N} is at least one of the following signals:
an indication signal i(fₙ) indicating the given frequencies {fₙ}_{n,1≤n≤N,1>N} emitted by the connected objects manager 5 to the connected neural stimulator/interface 1, 21′;
signals to be reproduced {sr(fₙ)}_{n,1≤n≤N,1>N}, {srₙ(fₙ)}_{n,1≤n≤N,1>N} with the given frequencies {fₙ}_{n,1≤n≤N,1>N} generated by the connected objects manager 5 and emitted by the connected objects manager 5 to the connected neural stimulator/interface 1, 21′;
an indication signal i(fₙ) indicating the given frequencies {fₙ}_{n,1≤n≤N,1>N} emitted by the connected neural stimulator/interface 1, 21′ to the connected objects manager 5.

In particular, the transmitter 54 comprises an emitter 540 emitting the signal relating to the given frequencies {fₙ}_{n,1≤n≤N,1>N} to the connected neural stimulator/interface 1, 21′.

In particular, the transmitter 54 comprises a receiver 540 for receiving the signal indicating the given frequencies i({fₙ}_{n,1≤n≤N,1>N}) from the connected neural stimulator/interface 1, 21′.

In particular, the connected objects manager 5 comprises a generator 53 for generating signals to be reproduced {sr(fₙ)}_{n,1≤n≤N,1>N}, {srₙ(fₙ)}_{n,1≤n≤N,1>N} with given frequencies {fₙ}_{n,1≤n≤N,1>N}. The signals to be reproduced generated in this way are capable of being reproduced by a connected neural stimulator/interface 1, 21′. In particular, the generator 53 supplies the signals to be reproduced, possibly generated {sᵣ(fₙ)}_{n,1≤n≤N,1>N}, {srₙ(fₙ)}_{n,1≤n≤N,1>N} with an identifier identifying the destination connected neural stimulator/interface idk, to the transmitter 54, in particular to the emitter 540.

A neural stimulator/interface 1, 21′ connected to a communication network 3 is capable of reproducing signals to be reproduced {sr(fₙ)}_{n,1≤n≤N,1>N}, {srₙ(fₙ)}_{n,1≤n≤N,1>N} with given frequencies {fₙ}_{n,1≤n≤N,1>N}. The given frequencies {fₙ}_{n,1≤n≤N,1>N} are possibly associated by the connected objects manager 5 with different given directions of adjustment {dr}_{n,1≤n≤N,1>N} of a command parameter pci of an electronic equipment 2 connected to the communication network 3. The connected neural stimulator/interface 1, 21′ is separate from the electronic equipment 2.

Therefore, an electronic equipment 2 that is not provided with a screen or other types of visual and/or audio reproduction device may have a BCI function, i.e., a neural interface, added to it by means of the connected neural stimulator/interface and the connected objects manager according to the invention.

In particular, the connected neural stimulator/interface 1, 21′ is a neural stimulator/interface as described with FIG. 1a connected to the communication network 3, in particular by means of a transmitter 14.

The connected neural stimulator/interface 1, 21′ comprises, in particular, a receiver 14 capable of receiving:
either the indication signal i({fₙ}_{n,1≤n≤N,1>N}) indicating the given frequencies {fₙ}_{n,1≤n≤N,1>N} emitted by the connected objects manager 5 to the connected neural stimulator/interface 1, 21′;
or the signals to be reproduced {sr(fₙ)}_{n,1≤n≤N,1>N}, {srₙ(fₙ)}_{n,1≤n≤N,1>N} with the given frequencies {fₙ}_{n,1≤n≤N,1>N} generated by the connected objects manager 5 and emitted by the connected objects manager 5 to the connected neural stimulator/interface 1, 21′.

In particular, the connected neural stimulator/interface comprises a generator 13 for generating signals to be reproduced {sr(fₙ)}_{n,1≤n≤N,1>N}, {srₙ(fₙ)}_{n,1≤n≤N,1>N} with given frequencies {fₙ}_{n,1≤n≤N,1>N}, for example as a function of the given frequencies {fₙ}_{n,1≤n≤N,1>N} received with the indication signal i({fₙ}_{n,1≤n≤N,1>N}) indicating the given frequencies {fₙ}_{n,1≤n≤N,1>N} from the objects manager 5.

In particular, the connected neural stimulator/interface 1, 21′ and the electronic equipment 2 are two separate devices in that the connected neural stimulator/interface 1, 21′ and the electronic equipment 2 are distinct from each other. “Connected neural stimulator/interface 1, 21′ separate from the electronic equipment 2” should be understood in particular to refer to the fact that the electronic equipment 2 does not comprise or implement the connected neural stimulator/interface 1, 21′.

In particular, the given directions of adjustment {dr}_{n,1≤n≤N,1>N} are identical to directions of adjustment triggered by a physical button 21 of the electronic equipment 2. The connected neural stimulator/interface 1, 21′ is physically associated ph_ass with the physical button 21.

“Physically associated” should be understood to refer to the fact that the connected neural stimulator/interface is positioned in the geographical proximity of the physical button or the signing of the physical button with which it is associated. “Geographical proximity” should be understood to refer to the fact that the connected neural stimulator/interface is positioned or reproduces the signal to be reproduced as if the source of the stimulus resulting from the reproduction of the signal to be reproduced was positioned (spatialized reproduction) directly on the physical button, or at a distance from the associated physical button less than the distance to the physical button of the electronic equipment the closest to the associated physical button, or indeed, if the electronic equipment is provided with several equipments positioned on the same straight line, on a straight line perpendicular to this straight line passing through the associated physical button, etc.

Therefore, BCI interaction errors are reduced because the connected neural stimulator/interface that reproduces the stimulus for the direct neural interaction is physically associated with the physical button of the interaction to be triggered. Therefore, the user performing an action (for example looking) in relation to the button with which he or she wishes to interact perceives, at the same time, the signals to be reproduced, reproduced by the physically associated connected neural stimulator/interface. More particularly, the user will interact with (for example will look at) one of the signals to be reproduced, reproduced by the physically associated connected neural stimulator/interface, which triggers an EEG signal with a frequency corresponding to the given frequency fₙ of one of the signals to be reproduced, reproduced by the connected neural stimulator/interface, which is itself associated with a given direction of adjustment of the physical button.

A physical button 21 is, in particular, a button as defined for FIG. 1a.

In particular, in the case of an electronic equipment 2 provided with several physical buttons {21i}_{i=1 . . . n . . . . N} including the physical button 21, different connected neural stimulators/interfaces are associated with different physical buttons of the electronic equipment 2 including the connected neural stimulator/interface 21′ associated with the physical button 21. Some or all of the physical buttons of the electronic equipment 2 are possibly associated respectively with a different connected neural stimulator/interface, reproducing signals to be reproduced with different given frequencies.

In particular, the connected neural stimulator/interface 1, 21′ comprises a fastening 11 capable of holding the connected neural stimulator/interface 1, 21′ in relation to the physical button 21.

Therefore, the connected neural stimulator/interface cannot move, limiting interaction errors linked to the loss of the physical association of the connected neural stimulator/interface with the physical button whose given directions of adjustment are associated with the given frequencies {fₙ}_{n,1≤n≤N,1>N} of the signals to be reproduced {sr(fₙ)}_{n,1≤n≤N,1>N}, {srₙ(fₙ)}_{n,1≤n≤N,1>N} reproduced by the connected neural stimulator/interface.

Advantageously, the connected neural stimulator/interface 1, 21′ comprises a rechargeable battery 12. In particular, the connected neural stimulator/interface 1, 21′ may be connected for power supply purposes to any electronic device, such as the electronic equipment 2, a computer, a tablet, etc. in particular by means of a USB cable, in order to be recharged, or indeed to a power socket via a battery charger.

An electronic equipment 2 comprises a regulator 260 (not shown) capable of adjusting a command parameter pci of a component 20 of the electronic equipment 2 in several different given directions of adjustment {dr}_{n,1≤n≤N,1>N}. A given direction of adjustment {dr}_{n,1≤n≤N,1>N} is a function of a neural frequency f_{ecg} emitted by a direct neural interface 4 during the reproduction of a signal to be reproduced with a given frequency {sr(fₙ)}_{n,1≤n≤N,1>N}, {srₙ(fₙ)}_{n,1≤n≤N,1>N} by a neural stimulator/interface. The emitted neural frequency f_{ecg} is a function of one of the given frequencies f_{n,1≤n≤N,1>N}. The different given directions of adjustment {dr}_{n,1≤n≤N,1>N} are associated with different given frequencies {fₙ}_{n,1≤n≤N,1>N}.

For example, the connected objects manager 5 supplies to the electronic equipment 2, more particularly to the regulator 260, a given direction of adjustment drₙ for adjusting the command parameter pci of the equipment 2 as a function of a neural frequency f_{ecg} emitted by the direct neural interface 4 during the reproduction of signals to be reproduced {sr(fₙ)}_{n,1≤n≤N,1>N}, {srₙ(fₙ)}_{n,1≤n≤N,1>N} with given frequencies {fₙ}_{n,1≤n≤N,1>N} by a connected neural stimulator/interface 1, 21′. The emitted neural frequency f_{ecg} is a function of a given frequency fₙ associated with the given direction of adjustment drₙ.

In particular, the connected electronic equipment 2 is an electronic equipment as described with FIG. 1a connected to the communication network 3, in particular by means of a transmitter 24.

In particular, the electronic equipment 2 is connected to the communication network 3 to which a connected neural stimulator/interface 1, 21′ is connected.

In particular, the electronic equipment 2 comprises a communication interface 24 capable of receiving a given direction of adjustment drₙ of a command parameter pci from a connected objects manager 5 via the communication network 3 as a function of a neural frequency f_{ecg} received from a direct neural interface 4 during the reproduction of signals to be reproduced {sr(fₙ)}_{n,1≤n≤N,1>N}, {srₙ(fₙ)}_{n,1≤n≤N,1>N} with given frequencies {fₙ}_{n,1≤n≤N,1>N} by the connected neural stimulator/interface 1. The received neural frequency f_{ecg} is a function of the given frequency fₙ associated with the given direction of adjustment drₙ.

In particular, the electronic equipment 2 comprises a power supply of the connected neural stimulator/interface 22 when the connected neural stimulator/interface 1, 21′ is associated with a physical button 21 of the electronic equipment 2.

In particular, the power supply 22 implemented in the electronic equipment 2 recharges the battery 12 of the connected neural stimulator/interface 1, 21′ in particular when the connected neural stimulator/interface 1, 21′ is connected to the electronic equipment 2, for example by cable, by induction, etc.

In particular, the power supply for the connected neural stimulator/interface 22 is one of the following power supplies:
a power supply connector capable of being connected to the connected neural stimulator/interface when the connected neural stimulator/interface is associated with a physical button of the electronic equipment;
an induction charger capable of recharging a battery of the connected neural stimulator/interface when the connected neural stimulator/interface is associated with a physical button of the electronic equipment.

A direct neural interface 4 is capable of sensing a frequency f_{ecg} relating to a user U during the reproduction of signals to be reproduced {sr(fₙ)}_{n,1≤n≤N,1>N}, {srₙ(fₙ)}_{n,1≤n≤N,1>N} with given frequencies {fₙ}_{n,1≤n≤N,1>N}. The direct neural interface 4 comprises an emitter 44 (not shown) emitting the sensed neural frequency f_{ecg} to a connected objects manager via a communication network 3. The emitter emitting the sensed neural frequency is capable of triggering an adjustment of a command parameter pci of an electronic equipment 2 in a given direction drₙ associated with the given frequency fₙ of a signal to be reproduced, reproduced by a neural stimulator/interface 1, 21′ connected to the communication network 3. The emitted neural frequency f_{ecg} is a function of the given frequency fₙ. In particular, the direct neural interface 4 comprises a communication interface 44 (not shown) comprising the emitter.

In particular, the direct neural interface 4 is capable of being connected to a connected objects manager 5.

In particular, the direct neural interface 4 is a direct neural interface as described with FIG. 1a connected to the communication network 3, in particular by means of the communication interface 44.

The communication interface 44 is in particular capable of being connected to a connected objects manager 5. The communication interface 44 is capable of transmitting to the connected objects manager 5 the neural frequency f_{ecg} sensed during the reproduction of signals to be reproduced {sr(fₙ)}_{n,1≤n≤N,1>N}, {srₙ(fₙ)}_{n,1≤n≤N,1>N} with given frequencies {fₙ}_{n,1≤n≤N,1>N} by the connected neural stimulator/interface 1.

Given reproduction frequencies {fₙ}_{n,1≤n≤N,1>N} of signals to be reproduced {sr(fₙ)}_{n,1≤n≤N,1>N}, {srₙ(fₙ)}_{n,1≤n≤N,1>N} by a neural stimulator/interface 1 connected to a communication network 3 are associated by the connected objects manager 5 with different given directions of adjustment {dr}_{n,1≤n≤N,1>N} of a command parameter pci of an electronic equipment 2 connected to the communication network 3. The connected neural stimulator/interface 1 and the electronic equipment are separate.

The connected neural stimulator/interface 1, 21′ is possibly physically associated ph_ass with a physical button 21 of the electronic equipment. Operating the physical button triggers the adjustment of the parameter pci of the electronic equipment 2 in the given direction of adjustment drₙ.

In particular, in parallel with the physical association ph_ass the connected objects manager 5 associates, in particular by means of a pairing unit 50, the given directions of adjustment drₙ of a command parameter pci corresponding to the physical button 21 with given frequencies {fₙ}_{n,1≤n≤N,1>N} that can be used by the connected neural stimulator/interface 1 to reproduce signals to be reproduced {sr(fₙ)}_{n,1≤n≤N,1>N}, {srₙ(fₙ)}_{n,1≤n≤N,1>N}.

In particular, the connected objects manager 5 transmits, in particular by means of a transmitter 54 and/or more particularly an emitter 540, to the connected neural stimulator/interface 1, 21′, signals to be reproduced {sr(fₙ)}_{n,1≤n≤N,1>N}, {srₙ(fₙ)}_{n,1≤n≤N,1>N} with the given frequencies or an indication signal indicating the given frequencies i({fₙ}_{n,1≤n≤N,1>N}). The signals to be reproduced {sr(fₙ)}_{n,1≤n≤N,1>N}, {srₙ(fₙ)}_{n,1≤n≤N,1>N} with the given frequencies emitted by the connected objects manager 5 are possibly generated by the connected objects manager 5, in particular by a generator for generating signals to be reproduced 53.

In particular, the reproduction device 10 of the connected neural stimulator/interface 1, 21′ reproduces the signals to be reproduced {sr(fₙ)}_{n,1≤n≤N,1>N}, {srₙ(fₙ)}_{n,1≤n≤N,1>N} with the given frequencies, in particular after receiving the signals to be reproduced {sr(fₙ)}_{n,1≤n≤N,1>N} or a signal indicating the given frequencies i({fₙ}_{n,1≤n≤N,1>N}), in particular by means of a receiver 14. Optionally, the connected neural stimulator/interface 1 generates, in particular via a generator 13 for generating signals to be reproduced, the signals to be reproduced {sr(fₙ)}_{n,1≤n≤N,1>N}, {srₙ(fₙ)}_{n,1≤n≤N,1>N} with the given frequencies as a function of the indication signal indicating given frequencies i({fₙ}_{n,1≤n≤N,1>N}) received from the connected objects manager.

When the user U performs an action in relation to a stimulus st(fₙ), stₙ(fₙ) (in particular, looking at it), in particular a visual stimulus, resulting from the reproduction of the signal to be reproduced with the given frequency fₙ reproduced by the connected neural stimulator/interface 1 during the reproduction of the signals to be reproduced {sr(fₙ)}_{n,1≤n≤N,1>N}, {srₙ(fₙ)}_{n,1≤n≤N,1>N}, a direct neural interface 4 senses a neural frequency f_{ecg} relating to the user U. The sensed neural frequency f_{ecg} and the given frequency fₙ have the same value.

The direct neural interface 4 supplies the sensed neural frequency f_{ecg}, in particular to the connected objects manager 5, via the communication network 3, in particular by means of an emitter 44. A given direction of adjustment drₙ that is a function of the sensed neural frequency is used by the electronic equipment 2.

The electronic equipment 2 possibly receives the given direction of adjustment drₙ from a controller 51, in particular from an analyzer 510, in particular implemented in the connected objects manager 5, as a function of the neural frequency emitted by the direct neural interface 4 and the pairing associating a given direction of adjustment and a given frequency (drₙ,fₙ).

In particular, a communication terminal of the user comprises a configuration interface (not shown) of the connected objects manager 5. This configuration interface allows the user to command the pairing unit 50 of the connected objects manager to associate different given directions of adjustment {dr}_{n,1≤n≤N,1>N} of a command parameter pci of the electronic equipment 2 with given frequencies {fₙ}_{n,1≤n≤N,1>N} of the connected neural stimulator/interface 1. The configuration interface is in particular implemented on the communication terminal in the form of an application.

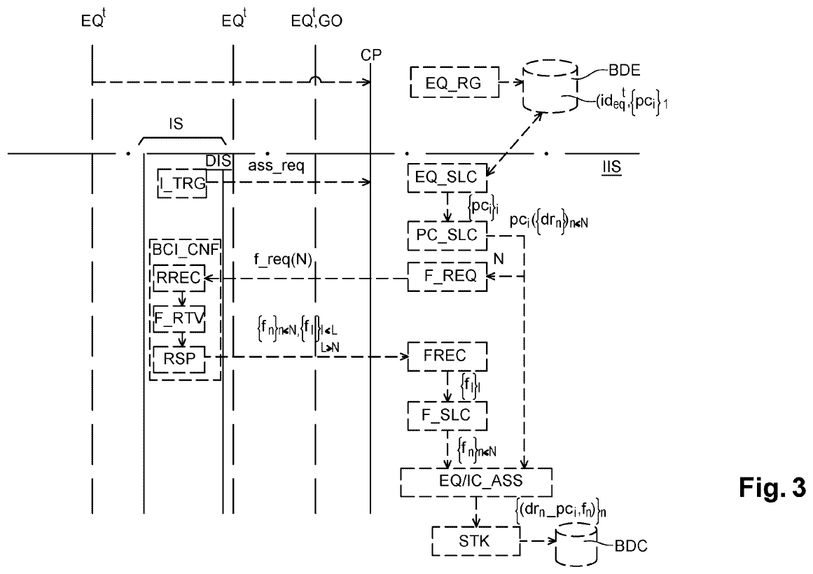

FIG. 3 shows a simplified diagram of exchanges during the implementation of a method for initializing a neural stimulator/interface according to the invention.

A method IIS for initializing a neural stimulator/interface IS, in particular connected to a communication network, and an electronic equipment EQt, in particular connected to the communication network. The initialization method IIS comprises a pairing procedure EQ/IC_ASS associating given frequencies {fₙ}ₙ of signals to be reproduced {sr(fₙ)}ₙ, {srₙ(fₙ)}ₙ reproduced by a neural stimulator/interface IS, possibly connected to a communication network, with given directions of adjustment {drₙ}ₙ of a command parameter pci of an electronic equipment EQt, possibly connected to the communication network.

In particular, the initialization method IIS comprises, prior to the pairing procedure EQ/IS_ASS, selecting EQ_SLC one of several electronic equipments in particular managed by a connected objects manager GO. The selection of electronic equipment EQ_SLC supplies, in particular, the command parameters {pci}i capable of being adjusted during the implementation of a command cmd by the selected electronic equipment EQt. The selection of electronic equipment EQ_SLC possibly retrieves the list of command parameters {pci}i capable of being adjusted by the selected electronic equipment EQt, either from the selected electronic equipment EQt (option not shown), or from a storage device, in particular an electronic equipment database BDE possibly implemented in a connected objects manager GO or in an electronic equipment EQt.

In particular, the initialization method IIS comprises, prior to the pairing procedure EQ/IS_ASS, selecting command parameters of an electronic equipment PC_SLC, in particular from a list of command parameters {pcᵢ}ᵢ of a previously selected electronic equipment EQt_SLC. If a neural stimulator/interface IS is physically associated with a physical button of the electronic equipment EQt, the directions of adjustment {drₙ}ₙ of the selected command parameter pci, also referred to as the given direction of adjustment, correspond to the directions of adjustment triggered by the action of a user U on the physical button of the electronic equipment EQt.

In particular, the initialization method IIS comprises, prior to the pairing procedure EQ/IS_ASS, a neural configuration BCI_CNF providing given frequencies {fₙ}ₙ capable of being used by the neural stimulator/interface IS that is being associated with the electronic equipment EQt.

In particular, the initialization method IIS comprises, prior to the pairing procedure EQ/IS_ASS, a frequency reception FREC, which involves receiving, from the neural stimulator/interface IS: either a list of frequencies {fₗ}_{l,l<L, L>N} capable of being used by the neural stimulator/interface IS to reproduce a visual signal, or the given frequencies {fₙ}ₙ. In particular, the neural configuration BCI_CNF comprises the frequency reception FREC.

In particular, the initialization method IIS comprises, prior to the frequency reception FREC, a frequency request REQ emitting, and possibly generating prior to the emission, a request for a frequency f_req to the neural stimulator/interface IS. In particular, the neural configuration BCI_CNF comprises the frequency request REQ prior to the frequency reception FREC.

In particular, the initialization method IIS comprises, prior to the pairing procedure EQ/IC_ASS, selecting F_SLC given frequencies {fₙ}ₙ from the frequencies {fₗ}ₗ capable of being used by the neural stimulator/interface IS that is being associated with the electronic equipment EQt. In particular, the neural configuration BCI_CNF comprises selecting given frequency F_SLC.

In particular, the initialization method IIS comprises storing STCK given direction of adjustment/given frequency pairs {(drₙ,fₙ)}ₙ provided by the pairing procedure EQ/IS_ASS. The storing procedure STCK records the given direction of adjustment/given frequency pairs {(drₙ,fₙ)}ₙ in a storage device, in particular a database of command parameters BDC.

In particular, the initialization method IIS is triggered by an association request ass_req from the neural stimulator/interface IS to the electronic equipment EQt. In particular, the neural stimulator/interface IS implements an initialization trigger I_TRG emitting the association request ass_req.

In particular, a neural stimulator/interface declaration method DIS is implemented by the neural stimulator/interface IS. The neural stimulator/interface declaration method DIS comprises the initialization trigger I_TRG.

The neural stimulator/interface declaration method DIS possibly comprises a frequency declaration RSP sending, to the initialization method, in particular to the frequency reception FREC, either a list of frequencies {fₗ}ₗ capable of being used by the neural stimulator/interface IS to reproduce signals to be reproduced, or the given frequencies {fₙ}ₙ.

In particular, the neural stimulator/interface declaration method DIS comprises, prior to the frequency declaration RSP, a search F_RTV for the frequencies that can be used by the neural stimulator/interface IS. The frequency search F_RTV reads the frequencies that can be used that have previously been stored in a storage device, in particular a frequency database BDF possibly implemented in the neural stimulator/interface IS.

In particular, the neural stimulator/interface declaration method DIS comprises, prior to the frequency declaration RSP and, if applicable, to the frequency search F_RTV, receiving a frequency request RREC from the initialization method IIS.

In one particular embodiment, prior to the initialization method IIS, an electronic equipment EQt implements an equipment declaration method DEQt. The equipment declaration method DEQt sends, in particular via the communication network to which it is connected, a registration request reg_req to an equipment registration method EQ_REG in particular implemented by an electronic equipment EQt or the connected objects manager GO. The registration request comprises, in particular, a list of the command parameters {pcdᵢ}ᵢ capable of being implemented by the electronic equipment EQt.: reg_req({pci}i).

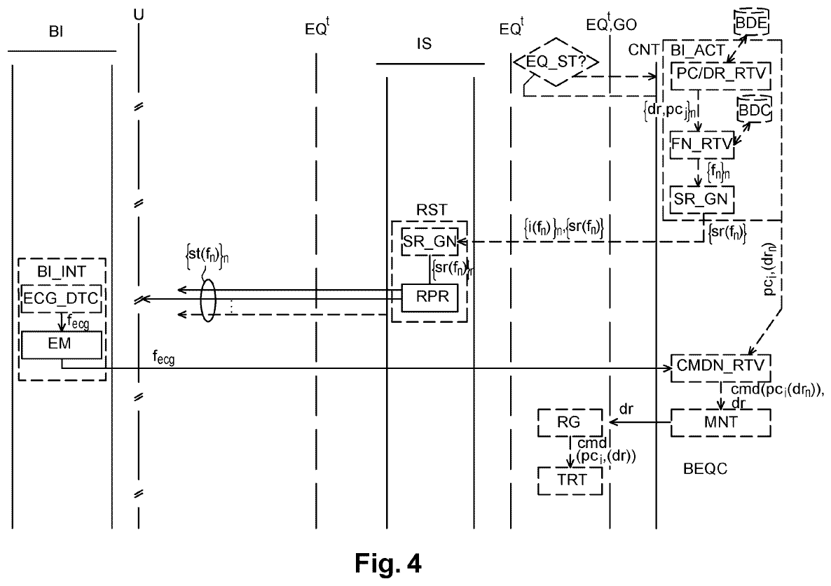

FIG. 4 shows a simplified diagram of exchanges during the implementation of a method for controlling an electronic equipment using a neural stimulator/interface according to the invention.

A method BEQC for controlling an electronic equipment adjusts, in a given direction of adjustment drₙ, a command parameter pci of an electronic equipment EQt, in particular connected to a communication network, as a function of a neural frequency f_{ecg} received from a direct neural interface BI during the reproduction of a signal to be reproduced sr(fₙ) with a given frequency fₙ by the neural stimulator/interface IS. The received neural frequency f_{ecg} is a function of the given frequency fₙ.

In particular, the control method BEQC is implemented by an electronic equipment EQt or a connected objects manager GO.

In particular, the control method BEQC comprises activating BI_ACT the reproduction RPR of signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N}, in particular implemented by a neural stimulator/interface IS. A stimulation method RST, in particular implemented by the neural stimulator/interface IS, comprises reproducing RPR the signals to be reproduced with the given frequencies {sr(fₙ)}_{n,1≤n≤N,1>N}, {srₙ(fₙ)}_{n,1≤n≤N,1>N}.

In particular, the activation BI_ACT of the reproduction of signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N} comprises a neural stimulation emitter EM emitting a signal.

In particular, the triggering EM emits a signal relating to the given frequencies {fₙ}_{n,1≤n≤N,1>N} used during the reproduction RPR of signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N}. The signal emitted by the triggering EM is, in particular:
either a signal i({fₙ}_{n,1≤n≤N,1>N}) indicating the given frequencies {fₙ}_{n,1≤n≤N,1>N} for the reproduction VRPR and/or the visual stimulation method VST;
or the signals to be reproduced {sr(fₙ)}_{n,1≤n≤N,1>N}, {srₙ(fₙ)}_{n,1≤n≤N,1>N} with given frequencies of the reproduction RPR and/or the stimulation method RST.

In particular, the stimulation method RST comprises, prior to the reproduction RPR, generating SR_GN signals to be reproduced {sr(fₙ)}_{n,1≤n≤N,1>N}, {srₙ(fₙ)}_{n,1≤n≤N,1>N} with given frequencies {fₙ}_{n,1≤n≤N,1>N} indicated in the indication signal i({fₙ}_{n,1≤n≤N,1>N}) from the triggering EM.

In particular, the method for controlling electronic equipment BEQC comprises, prior to the triggering EM of the reproduction of signals to be reproduced {sr(fₙ)}_{n,1≤n≤N,1>N}, {srₙ(fₙ)}_{n,1≤n≤N,1>N} with given frequencies {fₙ}_{n,1≤n≤N,1>N}, a search FN_RTV of the given frequencies associated with the directions of adjustment of a command parameter of the electronic equipment EQt. In particular, the search of given frequencies FN_RTV, in particular in a storage device such as a database of command parameters BDC, for example the database of command parameters of FIG. 3.

In particular, the method for controlling electronic equipment BEQC comprises, prior to the triggering EM of the reproduction of signals to be reproduced {sr(fₙ)_{n,1≤n≤N,1>N}, {srₙ(fₙ)}_{n,1≤n≤N,1>N} with different given frequencies {fₙ}_{n,1≤n≤N,1>N}, generating SR_GN signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N} indicated in the indication signal i({fₙ}_{n,1≤n≤N,1>N}) from the triggering EM.

In particular, the method for controlling electronic equipment BECQ comprises, prior to the search of given frequencies FN_RTV, a search of the command parameters of the electronic equipment PC/DR_RTV, in particular in a storage device such as an electronic equipment database BDE, for example the electronic equipment database of FIG. 3, supplying a list of command parameters {pcᵢ}ᵢ capable of being implemented by the electronic equipment EQt.

The search of command parameters CMD_RTV is possibly triggered by an activation command bcic_on or a wake-up command bcic_wk of one or more connected neural stimulators/interfaces ICn associated with the electronic equipment EQt.

For example, checking the status of the electronic equipment EQ_ST? determines whether the equipment switches from a “switched off” or “deactivated” status to a “switched on” or “activated” status.

When a switch from the “switched off” or “deactivated” status to a “switched on” or “activated” status is detected [ON] by this check EQ_ST?, the check EQ_ST? emits an activation command bcic_on. The activation command bcic_on possibly comprises the list of command parameters {pcᵢ}ᵢ that can be adjusted by the electronic equipment EQt. The activation command bcic_on triggers the activation BI_ACT of the reproduction RPR of signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N} and/or the search of command parameters CMD_RTV.

When a switch from the “standby” status to a “switched on” or “activated” status is detected [WK] by this check EQ_ST?, the check EQ_ST? emits a wake-up command bcic_wk. The wake-up command bcic_wk possibly comprises the list of command parameters {pcᵢ}ᵢ capable of being adjusted by the electronic equipment EQt. The wake-up command bcic_wk triggers the activation BI_ACT of the reproduction RPR of signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N} and/or the search of commands CMD_RTV.

In particular, the method for controlling electronic equipment BEQC comprises, after the triggering EM of the reproduction of signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N}, supervising the electronic equipment MNT commanding the electronic equipment EQt by means of a command cmd(pci(drₙ)), a command parameter pci of which has been adjusted in a given direction of adjustment drₙ that is a function of a sensed neural frequency f_{ecg} coming from a direct neural interface BI during the reproduction RPR of signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N} by a neural stimulator/interface IS associated with the electronic equipment EQt.

In particular, the method for controlling electronic equipment BEQC comprises, after the triggering EM of the reproduction of signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N} and prior to the adjustment in the given direction of adjustment drₙ of the command parameter of the electronic equipment EQt, in particular the emission of the given direction of adjustment drₙ, or a command, a command parameter of which has been adjusted as a function of the given direction of adjustment cmd(pci(n)) by the supervision of the electronic equipment MNT, a search for given commands CMDN_RTV as a function of a sensed neural frequency f_{ecg} coming from a direct neural interface BI during the reproduction RPR of a signal to be reproduced with a given frequency sr(fn) by a neural stimulator/interface IS associated with the electronic equipment EQt. The search for given commands CMDN_RTV is carried out in a storage device such as the database of command parameters BDC, for example the database of command parameters of FIG. 3.

In particular, a neural interaction method BI_INT supplies the sensed neural frequency f_{ecg} coming from a direct neural interface BI during the reproduction RPR of the signal to be reproduced with a given frequency sr(fₙ) by a neural stimulator/interface IS associated with the electronic equipment EQt.

The neural interaction method BI_INT is in particular implemented by the direct neural interface BI.

In particular, neural frequency detection ECG_DTC supplies, during the reproduction VRPR of the signal to be reproduced with a given frequency sr(fₙ) by a neural stimulator/interface IS associated with the electronic equipment EQt, the sensed neural frequency. Neural frequency detection is, in particular, activated by an action of the user U of the direct neural interface BI such as the fact that the user U is looking at the stimulus st(fₙ), stₙ(fₙ) resulting from the reproduction RPR of the signal to be reproduced with the given frequency sr(fₙ), srₙ(fₙ) among the stimuli {st(fₙ)}_{n,1≤n≤N,1>N}, {stₙ(fₙ)}_{n,1≤n≤N,1>N} resulting from the reproduction of the signals to be reproduced {sr(fₙ)}_{n,1≤n≤N,1>N}, {srₙ(fₙ)}_{n,1≤n≤N,1>N}.

In particular, the neural interaction method BI_INT comprises neural frequency detection ECG_DTC.

In particular, a sensed neural frequency emission EM transmits, to the method for controlling electronic equipments BEQC, the neural frequency f_{ecg} sensed during the reproduction RPR of signals to be reproduced {sr(fₙ)}_{n,1≤n≤N,1>N}, {srₙ(fₙ)}_{n,1≤n≤N,1>N} with different given frequencies {fₙ}_{n,1≤n≤N,1>N} by a neural stimulator/interface IS associated with the electronic equipment EQt. In particular, the sensed neural frequency f_{ecg} emitted by the emission EM is supplied by the neural frequency detection ECG_DTC.

In particular, the neural interaction method BI_INT comprises the sensed neural frequency emission EM.

In particular, the given direction of adjustment drₙ triggers the adjustment RG, by the electronic equipment EQt or the objects manager GO, of a command parameter pci in the given direction of adjustment drₙ, or indeed the execution, by the electronic equipment EQt, of a processing operation TRT as a function of a parameterizable command cmd(pci), the adjusted command parameter pci(drₙ) of which is supplied by the adjustment RG: cmd(pci(drₙ)).

In one particular embodiment, a method for managing connected objects OCMNGT comprises a method for initializing IIC a connected neural stimulator/interface and a method for controlling electronic equipments BEQC. For a specific electronic equipment, the management method OCMNGT implements the method for initializing IIC at least one connected neural stimulator/interface associated with this specific electronic equipment prior to the implementation of the control method BEQC for this specific electronic equipment.

In one embodiment of the method IIS for initializing a neural stimulator/interface and/or the method BEQC for controlling an electronic equipment and/or the method OCMNGT for managing connected objects is a program comprising program code instructions for executing the steps of the method for initializing a connected neural stimulator/interface and/or the method for controlling an electronic equipment and/or the method for managing connected objects when said program is executed by a processor.

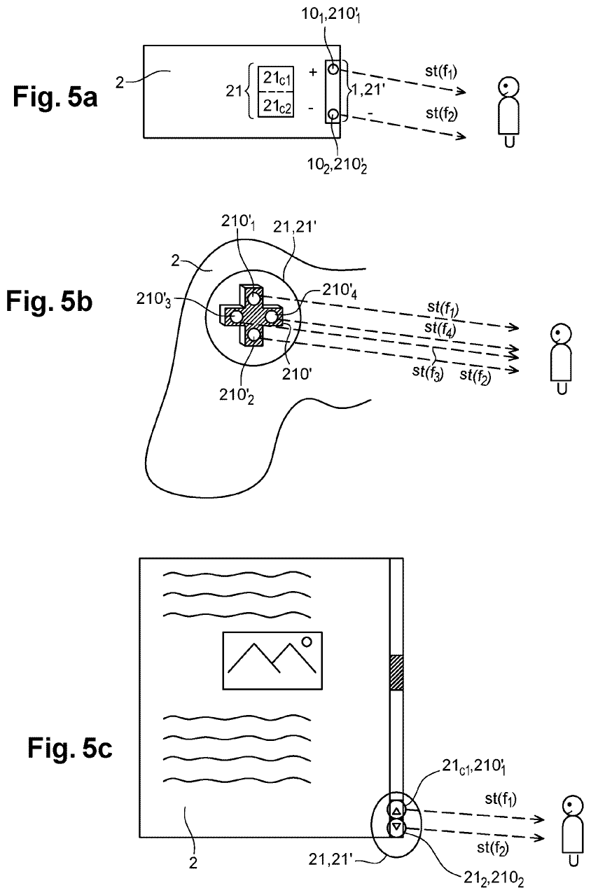

FIGS. 5a to 5c show simplified diagrams of a neural stimulator/interface issuing a given number of stimuli at different given frequencies associated with different elements of an electronic equipment according to the invention.

FIG. 5a shows a simplified diagram of a neural stimulator/interface issuing two stimuli at different given frequencies associated with two different positions of a physical button of an electronic equipment according to the invention.

FIG. 5a shows a physical button 21, in particular a toggle switch, which therefore has two command positions 21_{c1} and 21_{c2}, in particular via two contactors. An electronic equipment 2 comprises the physical button 21, in particular a simple electronic switch that can be positioned in a first “ON” position or in a second “OFF” position, and also a dimmer switch that can be positioned in a first “+” position or in a second “−” position for respectively increasing or decreasing the light intensity, etc.

The neural stimulator/interface 1, 21′ either is positioned on the equipment 2, or is implemented directly in the equipment 2. The neural stimulator/interface 1, 21′ reproduces two signals to be reproduced. This results in two stimuli, st(f1), st(f2) respectively, corresponding to the two positions of the physical button 21.

The neural stimulator/interface 1, 21′ possibly comprises two reproduction devices 10₁, 210₁ and 10₂, 210₂, such as two LEDs, issuing two stimuli, for example two visual signals, at two different frequencies f1 and f2.

In particular, the frequency f1 associated with the first position 21_{c1} of the physical button 21 is greater than the frequency f2 associated with the second position 21_{c2} of the physical button 21, when they are associated with an adjustment in an increasing and decreasing direction of the intensity parameter of the electronic equipment 2. This can also apply to a parameter such as volume.

FIG. 5b shows a simplified diagram of a neural stimulator/interface issuing four stimuli at different given frequencies associated with four different positions of a physical button of an electronic equipment according to the invention.

FIG. 5b shows a multi-position physical button 21 like those found on video game controllers, which are also referred to as gamepads, and therefore having several command positions, in this instance four 21_{c1}, 21_{c2}, 21_{c3}, and 21_{c4}, in particular via four contactors. An electronic equipment 2 comprises the physical button 2, in particular a remote control for navigating a screen, and also a video game controller or gamepad for virtual games or a real object whose position can be controlled (drone, radio-controlled vehicle, etc.). The physical button can be positioned in a first “high” position, a second “low” position, a third “left” position and a fourth “right” position.

The neural stimulator/interface 1, 21′ either is positioned on the equipment 2, or is implemented directly in the equipment 2. In the example of FIG. 5b, the equipment 2 comprises the neural stimulator/interface 21′. The neural stimulator/interface 21′ reproduces four signals to be reproduced. This results in four stimuli, st(f1), st(f2), st(f3), and st(f4) respectively, corresponding to the four positions of the physical button 21.

The neural stimulator/interface 21′ possibly comprises four reproduction devices 210₁, 210₂, 210₃, and 210₄ issuing four stimuli, for example four visual signals, at four different frequencies f1, f2, f3 and f4.

FIG. 5c shows a simplified diagram of a neural stimulator/interface issuing two stimuli at different given frequencies associated with two different zones of interaction of an interface displayed by an electronic equipment according to the invention.

FIG. 5c shows a virtual button 21 (in particular based on a touch-sensitive area of a touch screen) having two command positions 21_{c1} and 21_{c2}, in particular via two contact areas. An electronic equipment 2 comprises the virtual button 21, in particular a scroll bar slider that can be activated in a first “scroll up” position or in a second “scroll down” position as shown in FIG. 5c, and also a screen dimmer switch that can be positioned in a first “+” position or in a second “−” position for respectively increasing or decreasing the light intensity, etc.

The neural stimulator/interface 21′ reproduces two signals to be reproduced. This results in two stimuli, st(f1), st(f2) respectively, corresponding to the two positions of the virtual button 21.

The neural stimulator/interface 1, 21′ possibly comprises two areas of the screen corresponding to two visual reproduction devices 210₁ and 210₂ issuing two stimuli, for example two visual signals, at two different frequencies f1 and f2.

Therefore, the scroll up area 21_{c1} of the virtual button 21 on the screen will issue a stimulus at a first frequency st(f1) and the scroll down area 21_{c2} of the virtual button 21 on the screen will issue a stimulus at a second frequency st(f2).

In particular, the frequency f1 associated with the first position 21_{c1} of the physical button 21 is greater than the frequency f2 associated with the second position 21_{c2} of the physical button 21, when they are associated with an adjustment in an up or down direction of the movement parameter on the screen of the electronic equipment 2.

The invention also relates to an information medium. The information medium may be any entity or device capable of storing the program. For example, the support may comprise a storage means such as a ROM, for example a CD ROM or a microelectronic circuit ROM or indeed a magnetic recording medium, for example a floppy disk or a hard disk.

Moreover, the information medium may be a transmissible medium such as an electrical or optical signal that may be routed via an electrical or optical cable, by radio or by other means. The program according to the invention may in particular be downloaded from a network, in particular the Internet.

Alternatively, the information medium may be an integrated circuit in which the program is incorporated, the circuit being designed to execute or be used in the execution of the method in question.

In another implementation, the invention is implemented by means of software and/or hardware components. In this context, the term “module” may refer to either a software component or a hardware component. A software component corresponds to one or more computer programs, one or more sub-programs of a program or, more generally, to any element of a program or software that is capable of implementing a function or a set of functions according to the above description. A hardware component corresponds to any element of a hardware assembly that is capable of implementing a function or a set of functions.

1. A neural stimulator/interface comprising:
a reproduction device which is configured to reproduce at least one signal to be reproduced with several different given frequencies, the given frequencies being associated with different given directions of adjustment of a command parameter of an electronic equipment.

2. The neural stimulator/interface as claimed in claim 1, which comprises an order relationship between the given frequencies which is a function of an order relationship between the given directions of adjustment associated with the given frequencies.

3. The neural stimulator/interface as claimed in claim 1, in which a signal of the at least one signal to be reproduced with a given frequency of the several different given frequencies is different from a signal of the at least one signal to be reproduced with another given frequency of the several different given frequencies when the other given frequency is different from the given frequency.

4. The neural stimulator/interface as claimed in claim 1, in which the at least one to be reproduced comprises a first signal to be reproduced with a first given frequency and a second signal to be reproduced with a second given frequency, the first signal and the second signal being different.

5. The neural stimulator/interface as claimed in claim 1, in which the several different given frequencies are such that a difference between two given frequencies of the several different given frequencies is greater than a predetermined difference threshold.

6. The neural stimulator/interface as claimed in claim 1, in which the at least one signal to be reproduced is one of the following signals: an audio signal, a visual signal.

7. The neural stimulator/interface as claimed in claim 1, in which the neural stimulator/interface is one of the following interfaces: a neural stimulator/interface that is a component of the electronic equipment, a neural stimulator/interface connectable to a communication network to which the electronic equipment is connected.

8. A direct neural interface capable of sensing a neural frequency relating to a user during a reproduction of signals to be reproduced with different given frequencies by a neural stimulator/interface, wherein the direct neural interface comprises:
an emitter configured to emit the sensed neural frequency via a communication network and trigger an adjustment of a given command parameter of an electronic equipment, the given adjustment of the command parameter being carried out in a given direction of adjustment from among several different directions of adjustment of the command parameter of the electronic equipment, the different given directions of adjustment of the command parameter of the electronic equipment being associated with different given frequencies of the signals to be reproduced by the neural stimulator/interface and the given direction of adjustment being associated with one of the given frequencies of the signals to be reproduced by the neural stimulator/interface, the emitted neural frequency being a function of one of the given frequencies.

9. An electronic equipment comprising:
a regulator configured to adjust a command parameter of a component of the electronic equipment in several different given directions of adjustment, a given direction of adjustment of the several different given directions of adjustments being a function of a neural frequency emitted by a direct neural interface during a reproduction of signals to be reproduced with different given frequencies by a neural stimulator/interface, the emitted neural frequency being a function of one of the different given frequencies of the signals to be reproduced by the neural stimulator/interface, the several different given directions of adjustment being associated with the different given frequencies.

10. The electronic equipment as claimed in claim 9, in which the electronic equipment comprises the neural stimulator/interface.

11. The electronic equipment as claimed in claim 9, in which the electronic equipment comprises a transmitter, which is connectable to a communication network to which the neural stimulator/interface is connected.

12. A method comprising:
initializing a neural stimulator/interface, in which the initializing comprises a pairing procedure associating a given frequency of a signal to be reproduced by the neural stimulator/interface with a given direction of adjustment of a command parameter of an electronic equipment, wherein different given directions of adjustment of the command parameter of the electronic equipment are associated with different given frequencies.

13. A method comprising:
receiving a neural frequency from a direct neural interface during a reproduction of signals to be reproduced with different given frequencies by a neural stimulator/interface,
controlling an electronic equipment by adjusting, as a function of the received neural frequency, a command parameter of the electronic equipment in a given direction of adjustment from among several different directions of adjustment, the received neural frequency being a function of one of the different given frequencies, wherein different given directions of adjustment are associated with the different given frequencies.

14. A non-transitory computer readable medium comprising program code instructions stored thereon for executing the method as claimed in claim 12 when said program is executed by a processor.

15. A non-transitory computer readable medium comprising program code instructions stored thereon for executing the method as claimed in claim 13 when said program is executed by a processor.
